(19) United States
(12) Patent Application Publication
(10) Pub. No.: US 2005/0201085 A1
(43) Pub. Date: Sep. 15, 2005

(54) Telescopic flashlight

(76) Inventors: Takamine Aikawa, Gunma (JP); Kikuo Oya, Chiba (JP)

Correspondence Address: DARBY & DARBY P.C., P. O. BOX 5257, NEW YORK, NY, 10150-5257, US

(21) Appl. No.: 10/799,942

(22) Filed: Mar. 11, 2004

(51) Int. Cl. F21L 4/04

(52) U.S. Cl. 362/198; 362/287; 362/202; 362/800

(57) ABSTRACT

A telescopic flashlight of the present invention is constructed such that a light-emitting part having a power supply and a lighting member is mounted on the tip of a telescopic arm member, and a cap member in the shape of a cap is detachably mounted on the tip of the light-emitting part, and a magnet, a lens, or the like is attached to the cap member and is designed to be fit to the butt end of the telescopic arm member when it is not used. In addition, a mirror, a magnifying lens, or the like may be attached to the external side of the cap member.

### BACKGROUND OF THE INVENTION

1. Field of the Invention

The present invention relates to an improvement on a telescopic flashlight provided with a lighting member on the tip of a telescopic arm member.

2. Description of the Prior Art

Conventionally, there have been proposed various configurations of a flashlight having a lighting member on the tip of a telescopic arm member to allow the light member to be extended or shortened.

Concrete examples, which have been disclosed, include: a flashlight that comprises a power-supply housing part where a power-supply such as a battery or a secondary cell is housed, a telescopic arm member mounted on the power-supply housing part in a connected row arrangement, and an external lighting member mounted on the tip of the telescopic arm member and provided with electric power from the power supply (JP 09-237501 A); and a flashlight in which both an electric-supply member and a lighting member are mounted on the tip of a telescopic arm member (Japanese Utility Model Registration No. 3067105).

However, any of the conventional telescopic flashlights is constructed such that only the lighting member is allowed to be extended or shortened, so that there is a disadvantage in that the use thereof is limited to only illuminate a dark place.

In addition, if there is a need of fixing a magnet on a lighting cover, magnetic force always arises at the tip of the lighting cover. Thus, when another magnetic substance is located near the magnet on the cover at the time of irradiation in a desired direction, the magnet tends to be attracted by the magnetic substance, resulting in difficulty in arbitrarily control of the lighting direction.

### SUMMARY OF THE INVENTION

An object of the present invention is to provide a telescopic flashlight that comprises a telescopic arm member, a light-emitting member mounted on the tip of the telescopic arm member and constructed of an electric supply and a lighting member, and a light cover constructed of a cap member removably attached on the tip of the light-emitting body, where the cap member can be attached to the end of the telescopic arm member by fitting together.

The cap member may be colored with a predetermined color to allow colored-lighting.

Also, the cap member may have a magnet fixed on the tip thereof to allow the cap member to be attached on a light-emitting member with one-touch operation when needed for easily finding out parts such as a machine screw or a rivet of a small article being dropped on the ground in darkness by lighting with the light-emitting member.

The cap member can be fit in the butt end of the telescopic arm member to keep it therein when it is not used. Thus, the flashlight can be fit for various uses while excelling in convenience.

In other words, the flashlight can be used in various applications including professional-uses for car maintenance, mechanical repair and inspection, and multipurpose uses at home.

In addition, a joint part may be provided between the lighting member and the telescopic arm member to change the lighting direction.

Furthermore, the magnet may be fixed on an anterior or posterior portion of the telescopic flashlight.

Moreover, a mirror or a lens may be mounted on the cap member through an arm. In addition, a joint member may be provided on the arm to allow the mirror or lens to change its direction.

Providing a joint part on the above arm member allows the mirror or lens to change its direction.

Besides, a mirror or a magnifying lens may be attached on the external side of the cap member through an arm to light up an area to be observed through the mirror or magnifying lens.

Furthermore, the flashlight may be equipped with a clip to allow the flashlight to be used as auxiliary lighting during various kinds of maintenance, inspection, and repair works. For instance, the flashlight can be used while the clip can be hooked on a breast pocket.

### BRIEF DESCRIPTION OF THE DRAWINGS

FIG. 1 is a perspective view of the telescopic flashlight in an extended state, where the cap member is being attached on the tip of the telescopic flashlight by fitting them together;

FIG. 2 is a perspective view of the telescopic flashlight, where the cap member is being attached on the butt end of the flashlight by fitting them together;

FIG. 3 is a perspective view of the telescopic flashlight in a shortened state, where the cap member is being removed from the tip thereof.

FIG. 4 is a partial cross-sectional side view of the telescopic flashlight shown in FIG. 2, where the telescopic arm member is being shortened;

FIG. 5 is a side view of the telescopic flashlight shown in FIG. 2, where the telescopic arm member is being shortened;

FIG. 6 is a side view of the telescopic flashlight shown in FIG. 1, where the telescopic arm member is being shortened;

FIG. 7 is an enlarged cross-sectional view of the lighting member of the telescopic flashlight;

FIG. 8 is a cross-sectional view of the cap member;

FIG. 9 is a partial cross-sectional side view of the cap member of the telescopic flashlight according to another embodiment of the present invention;

FIG. 10 is a perspective view of the telescopic flashlight according to another embodiment of the present invention, where the battery housing part is shown;

FIG. 11 is a perspective view of the telescopic flashlight according to another embodiment of the present invention, where the joint part is shown;

FIG. 12 is a partial cross-sectional enlarged view of the principal part of the telescopic flashlight having another example of the joint part;

FIG. 13(a) is a side view of another example of the joint part and FIG. 13(b) is a plan view of still another example of the joint part;

FIG. 14 is a side view of the telescopic flashlight according to another embodiment of the present invention, where the magnet is fixed on the posterior portion of the main body;

FIG. 15 is a side view of the telescopic flashlight according to another embodiment of the present invention, where the magnet is fixed on the lighting member;

FIG. 16(a) is a side view of the telescopic flashlight in a state of being attached on the magnetic body by magnetic force, FIG. 16(b) is a side view of the telescopic flashlight in a state of being held on the breast pocket by hooking the clip thereon, and FIG. 16(c) is a side view of the telescopic flashlight using another joint part different from one used in FIG. 16(b);

FIG. 17(a) is a side view of the cap member equipped with the mirror or lens, 17(b) is a side view of the cap member equipped with the lens;

FIG. 18 is a front view of the mirror or lens holder;

FIG. 19 is a side view of the cap member having the shape different from one shown in FIG. 18.

### DESCRIPTION OF THE PREFERRED EMBODIMENTS

Hereinafter, preferred embodiments of the telescopic flashlight in accordance with the present invention will be described with reference to the attached figures.

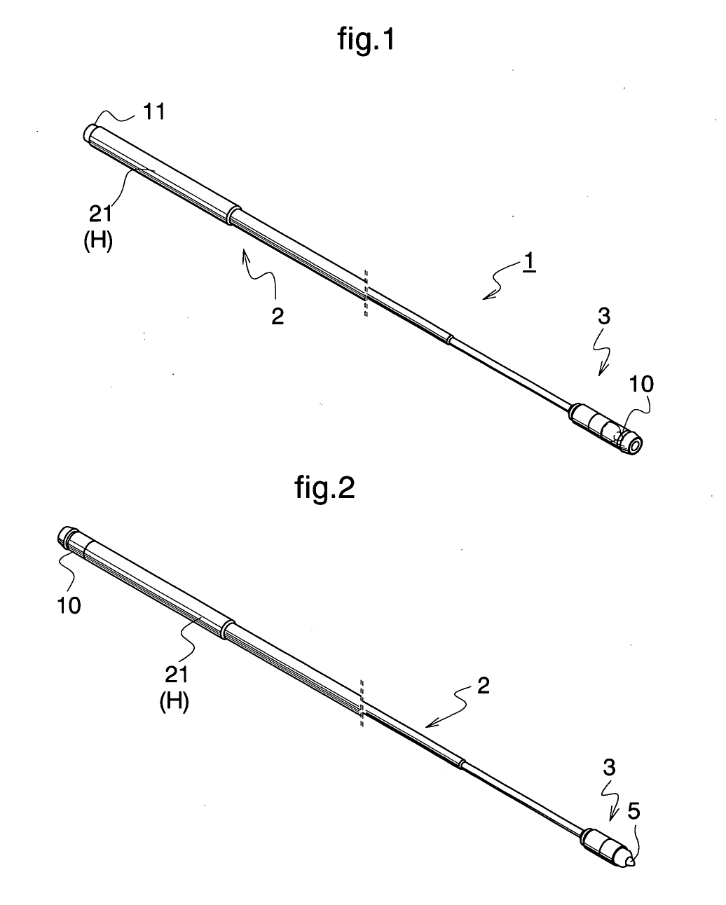

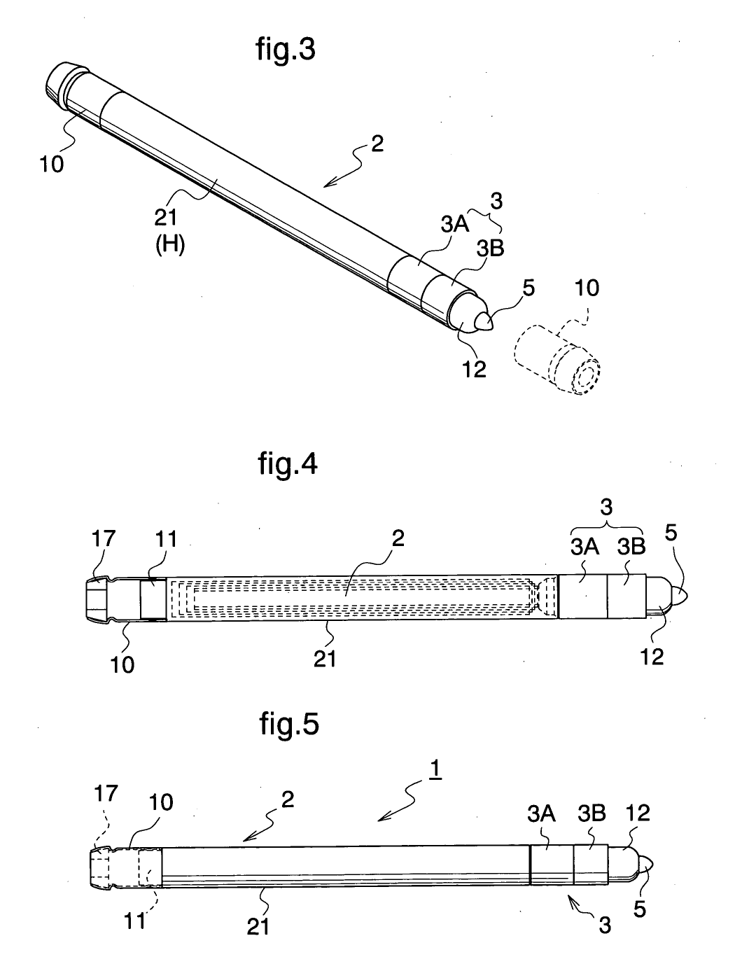

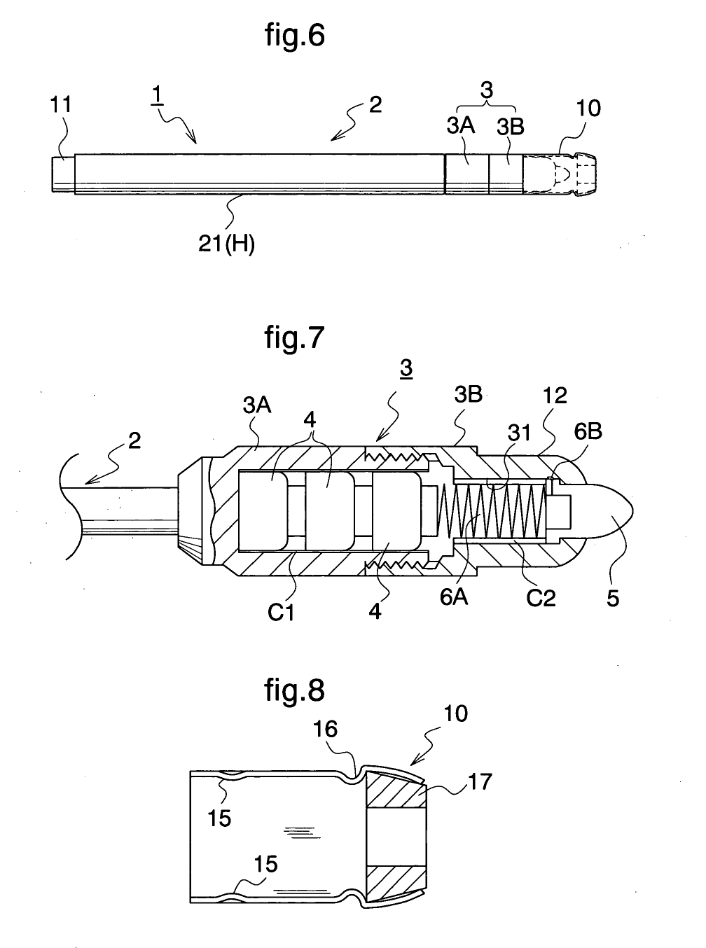

In each of FIGS. 1 to 6, there is shown a telescopic flashlight 1 as one of the preferred embodiments of the invention. The telescopic flash light 1 is made of stainless steel and is constructed of a telescopic arm member 2, a lighting member 3 mounted on the tip of the telescopic arm member 2, and a cap member 10 removably attached on the lighting member 3.

The telescopic arm member 2 is provided as a telescopic rod made of cylindrical sections (e.g., six sections) that fit or slide into each other so that it can be made longer or shorter. The outermost cylindrical section 21 is used as a holding member H. As shown in the figure, the bottom end (butt end) portion of the outermost cylindrical section 21 has a stepped portion from which a first cap-attaching portion 11 is formed such that the diameter of the portion 11 is made as small as the wall thickness of the cap member 10.

Next, the lighting member 3 is fixed on the tip of the telescopic arm member 2. In this embodiment, the lighting member 3 is designed to be a continuous rod shape such that the diameter of the lighting member 3 becomes generally coincident with the diameter of the telescopic arm member 2 when the latter is being shortened.

As shown in FIG. 7, the lighting member 3 comprises a battery-housing part 3A for holding a button type battery 4 which is shown as an example of a small-sized battery and an emitter-holding part 3B for holding a light-emitting member 5 constructed of a light-emitting diode (LED) that emits white light using the button type battery 4 as its electric source, where the emitter-holding part 3B is detachably connected to the battery-housing part 3A.

Here, the battery-housing part 3A has a cylindrical form with an open end. One or two or more button-type batteries (three batteries in the figure) arranged in a series are held in the cavity of a plastic tubular member C1 installed in the battery-housing part 3A.

In addition, the emitter-holding part 3B is of a generally cylindrical form and has an opening in its rear end and a pore portion 31 in its tip portion. The light-emitting member 5 is inserted into the pore portion 31.

The light-emitting member 5 is integrally attached with: an electric conductor 6A in the shape of a spring to be brought into contact with one terminal of the button-type battery 4; and an electric conductor 6B in the shape of a protrusion to be brought into contact with the inner peripheral wall of the emitter-holding part 3B for touching on the other terminal of the button-type battery 4.

In the figure, furthermore, the reference numeral C2 represents an insulative collar fitted in the pore portion 31.

In the present embodiment, the tip portion of the battery housing part 3A has a diameter slightly smaller than other portions and the outer peripheral wall of the tip portion is threaded to form a thread groove. On the other hand, the corresponding inner peripheral wall of the rear end portion of the emitter-holding part 3B is also threaded so as to be screwed to the above thread groove.

In the present embodiment, therefore, these threaded structures are acted as an ON-OFF switching assembly. Briefly, by twisting the emitter-holding part 3B to loose it from the battery housing part 3A, the end of the conductor 6B is detached from the button-type battery 4 to shut off an electric circuit to the power supply. On contrast, twisting the emitter-holding part 3B to fasten it on the battery housing part 3A, the electric circuit is allowed to be energized.

In this embodiment, however, the switch structure of the electric circuit for allowing the light-emitting member 5 to emit light is not limited to the above exemplified structure. Any of other switching means well known in the art, including sliding-type and push-type switching structures.

Next, a second cap-attaching portion 12 is formed.

Furthermore, for fitting in the cap member 10, the tip portion of the emitter holding part 3B has a stepped portion from which a second cap-attaching portion 12 is formed such that the diameter of the portion 12 is made as small as the wall thickness of the cap member 10.

The diameter of the second cap-attaching portion 12 and the diameter of the first cap-attaching portion 11 formed in the external cylindrical part 21 are equal to each other (i.e., the same diameter), so that the cap member 10 can be attached to each of them.

In FIG. 8, there is shown an example of the cap member 10. The exemplified cap member 10 is formed of a cylindrical stainless-steel color (the cross-sectional shape thereof is not limited to a specific one but it may be circular, elliptical, polygonal, or the like) where both ends thereof are opened and communicated with each other. In addition, at the mid position on the inner peripheral wall of the cap member 10, there is a protruded locking part 15 which is slightly protruded in an inward radial direction. On the tip side of the cap member 10, there is formed a narrowed part 16 having a smaller diameter for the retention thereof in place. In addition, a circular permanent magnet 17 is fixed on the tip of the cap member 10.

In the example shown in the figure, the magnet 17 has a trapezoidal cross section. The tip of the narrowed part 16 of the cap member 10 is crimped in a dovetail groove shape to lock the magnet 17 in place.

Alternatively, but not limited to, the magnet 17 may be fixed on the cap member 10 by means of an adhesive or the like or may be removably attached to the cap member.

As the cap member 10 has the circular magnet 17 on its tip, the camp member 10 can be attached to the emitter-holding part 3B with one-touch operation when needed. Thus, the attached cap member 10 covers the outer peripheral surface of the light-emitting part 5 while light is emitted from the light-emitting part 5 through the central opening of the magnet 17, for example, for easily finding out parts such as a machine screw or a rivet of a small article being dropped on the ground in darkness by lighting with the light-emitting member 5.

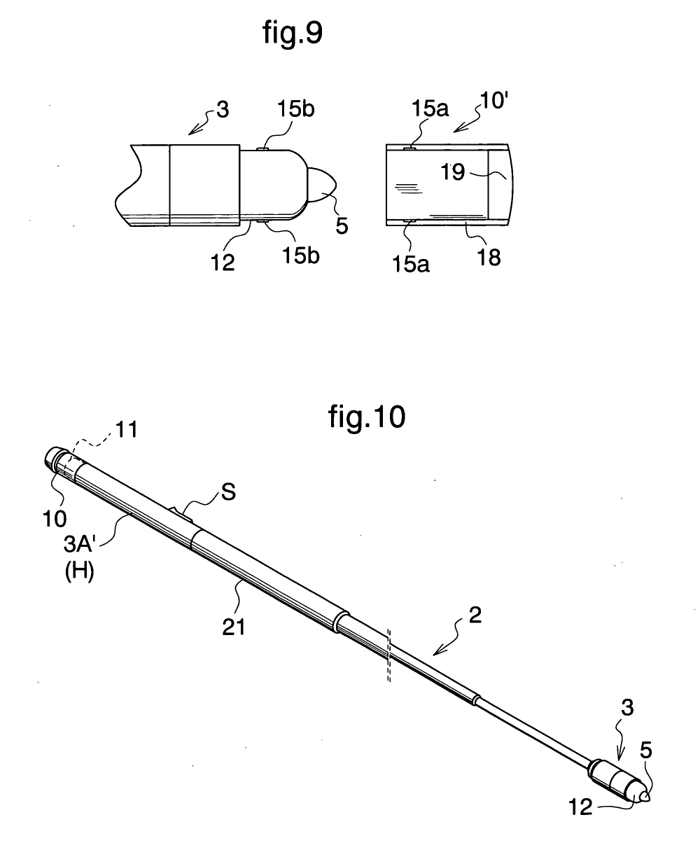

Referring now to FIG. 9, there is shown another example of the cap member 10′. A cap member 10′ is of a cylindrical form and has a transparent portion 18 formed of a transparent or translucent plastic collar at least near the light-emitting part 5. In addition, a lens 19 such as a plate lens or concavo-convex lens is fixed on the tip of the cap member 10′.

Furthermore, recessed portions 15a are formed in the inner peripheral wall of the cap member 10′. On the other hand, the corresponding protruded portions 15b are formed on the first cap-attaching portion 11 or the second cap-attaching portion 12 (not shown in FIG. 9) of the telescopic flashlight 1, so that the protruded portions 15b are detachably engaged with the respective recessed portions 15a to attach the cap member 10′ on the flashlight 1.

As the flashlight 1 is constructed above, the light from the light-emitting part 5 can be brightly emitted through the lens 19 by locking the cap member 10′ to the second cap-attaching portion 12 of the emitter-holding part 3B in place.

In contrast, when the peripheral wall of the cap member 10′ is made opaque, light can be concentrated by only emitting the light through the lens portion 19 located at the front of the tip of the cap member 10′.

Moreover, the cap member 10 can be used as a warning light attachment by coloring the lens 19 of the light-emitting part 5 and optionally the transparent or translucent portion with a predetermined color (e.g., red).

That is, when the cap member 10′ is expected to be used as a warning light, red-colored light can be emitted from the light-emitting part 5 by attaching the cap member 10 to the second cap-attaching portion 12 of the emitter-holding part 3B by latching them together.

In addition, when it is not used, the cap member 10′ can be housed without becoming an obstacle by detaching the cap member 10′ from the second cap-attaching portion 12 and then attaching the cap member 10′ to the first cap-attaching portion 11 of the external cylindrical part 2 by latching them together. Besides, it can be also used as a conventional flashlight.

In this manner, a functional part having various functions is provided on the cap member 10 or 10′ to increase the additional values of the flashlight. In addition, the cap member 10 or 10′ can be fit to the external cylindrical part 21 when it is not used, so that the cap member can be integrally housed therein until the next use.

In the above description, the exemplified telescopic flashlight 1 has the battery housing part 3A mounted on the tip of the telescopic arm member 2. In this invention, alternatively, the flashlight may be designed to use a battery or a secondary cell as a power source by connecting the battery housing part 3A′ to the butt end of the telescopic arm member in a row arrangement as disclosed in JP 09-237501 cited above (see FIG. 10).

In addition, the light-emitting part is not limited to LED. A midget lamp may be used.

In this case, the casing of the battery housing part 3A′ is provided as a handling member H. The first cap-attaching portion 11 is formed on the butt end of the handling member H.

Furthermore, a switch S may be provided on the battery housing part 3A′.

The other structural elements are similar to those of the embodiment described above, so that the explanations thereof will be omitted in the following description.

Furthermore, in the above example, the structure for latching the cap member, which is formed on the cylindrical body, is exemplified as a mechanism for attaching and detaching the cap member. Alternatively, a screw portion may be threaded on the inner wall of the cap member and also the portion on which the cap member is to be attached is threaded to form the corresponding screw portion.

Alternatively, furthermore, the cap member may be inserted with force just as in the case of a cap used in cosmetics such as a lipstick without providing the latching means, or the structure using other latching means to fit together and pull apart may be used.

In the above embodiment, there is illustrated the structure without a light cover on the light-emitting part. Alternatively, however, the present invention may be constructed such that a transparent light cover is attached to cover the light-emitting part.

In the above embodiment, there is illustrated the structure in which the cap member can be removably attached to the butt end of the handling and the tip of the lighting member. Alternatively, however, the present invention may be constructed such as the cap member is removably attached only to the tip of the lighting member (not shown).

In this embodiment, in contrast to the first cap-attaching portion 11 formed on the handling member H shown in FIG. 1 and FIG. 10, there is no first cap-attaching portion 11 arranged on the handling portion 11.

The cap member removed from the lighting member may be suitably housed independently of the telescopic flashlight or may be connected to the flashlight through a connecting device such as a chain or a cord.

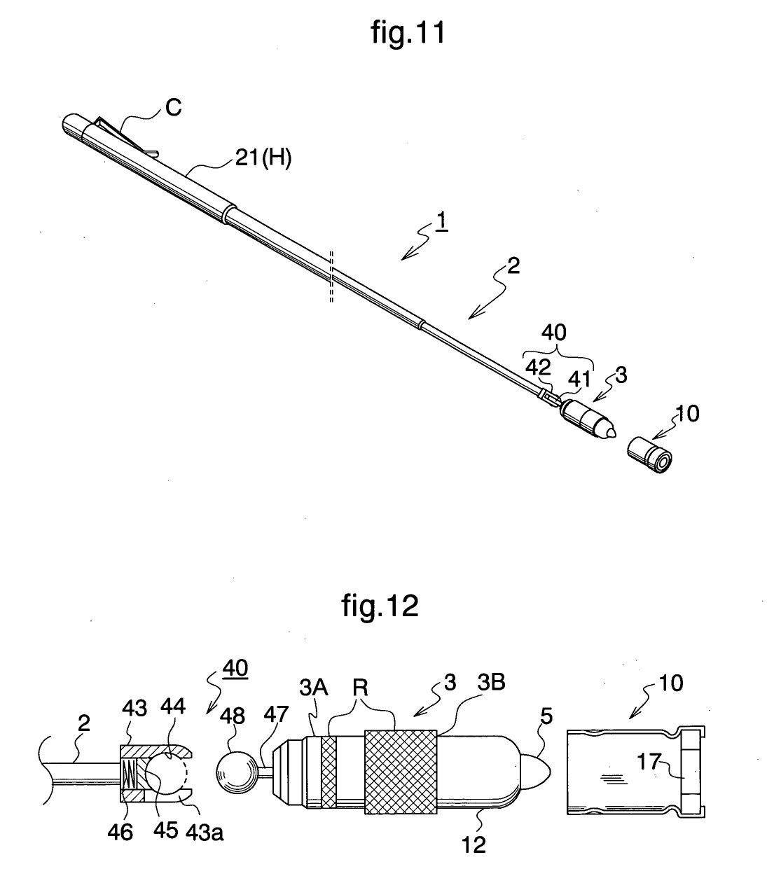

Referring now to FIG. 11, there is illustrated another embodiment of the telescopic flashlight 1 where the lighting member 3 is attached to the tip of the telescopic arm member 2 through a joint part 40.

In this embodiment, a pivotably supporting structure is used as the joint part 40. For example, an arm 41 is provided on the lower end of the lighting member 3 so as to be protruded therefrom, while a pair of brackets 42 is mounted on the tip of the telescopic arm member 2 so that the arm 41 is mounted so as to be able to swing.

Here, in this embodiment, the telescopic arm member 2 is pivotably mounted, so that the lighting member 3 can be able to turn around the telescopic arm member 2 as a center of rotation in a peripheral direction. At the desired pivotable position, the lighting member 3 is able to perform an angular motion while the point where joint part 40 is mounted so as to be able to swing is provided as a fulcrum.

Therefore, the telescopic flashlight is able to illuminate at a predetermined angle in addition to illuminate in the direction extended along the telescopic arm member 2.

By the way, the alphabet C in the figure represents a clip mounted on the external cylindrical part 21.

In FIG. 12, there is exemplified a structure using a spherical bearing instead of the above pivotably supporting structure.

That is, a spherical bearing member 43 is provided on the tip of the telescopic arm member 2so as to be protruded therefrom.

The spherical bearing member 43 is of a cylindrical shape and comprises a spherically recessed portion 44 having a slit 43a for allowing an axial part 47 described later to pass through the slit 43a for receiving a spherical body within the inside of the spherical bearing member 43, a retainer 45 having a receiving surface for receiving the spherical surface of the spherical body, and a spring 46 for applying force to the retainer in the direction of pressing the retainer against the spherical surface of the spherical body.

On the other hand, the spherical body 48 is provided on the butt end of the lighting member 3 through an axial portion 47 so as to be protruded.

Therefore, the spherical body 48 is brought into surface contact with both the recessed portion 44 and the retainer 45 to allow the lighting member 3 to be displaced in any direction.

Furthermore, the lighting member 3 can be inclined at a large angle by passing the axial portion 47 through the slit. Here, in the figure, R represents knurled portions for preventing slipping to turn the emitter-holding part 3B. The knurled portions R are provided on the battery housing part 3A and the emitter-holding part 3B, respectively.

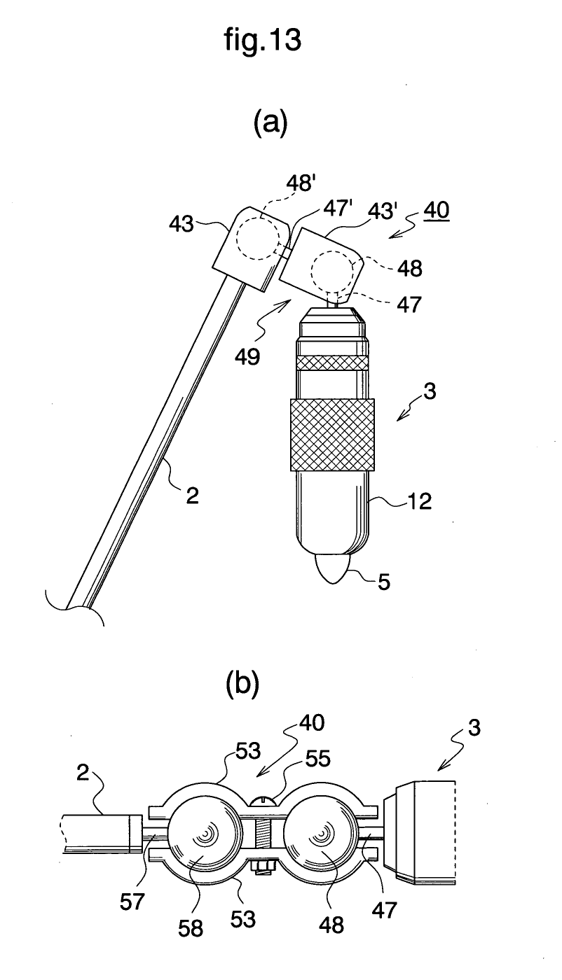

FIG. 13 illustrates another embodiment in which two double spherical bearing members 43 are arranged in tandem.

In FIG. 13(a), a relay spherical bearing member 49 is arranged between the spherical body 48′ and the spherical bearing member 43 of the above embodiment. The relay spherical bearing member 49 is provided with an additional spherical member 43′ independently from the spherical bearing member 43, and an axial portion 47′ and a spherical body 48′ fixed on the butt end of the spherical bearing member 43′. Therefore, it is possible to doubly adjust the angle of the lighting member 3 with respect to the telescopic arm member 2.

Consequently, the use of the telescopic flashlight 1 can be extended as the angle of light can be further increased. Thus, for example, in the case of using the telescopic flashlight 1 for various kinds of maintenance including inspection and maintenance of automobiles and machines, it is possible to easily illuminate any complicatedly bent place.

Likewise, in FIG. 13(b), an axial portion 57 and a spherical body 58 are integrally provided on the tip of the telescopic arm member 2 such that these additional components extend outward.

In addition, there is provided a pair of plate-like joint covers 53 having spherical recessed portions for receiving the spherical bodies 58, 48, respectively.

It is constructed such that the joint covers 53, 53 are aligned in place so as to be placed opposite to each other. The spherical bodies 58, 48 are sandwiched between the surfaces of the respective joint covers 53 and then clamped with a fixing device 55 such as a screw (e.g., a thumbscrew). Using the screw allows fine adjustment of the clamping force.

Consequently, two spherical bodies 58, 48 are respectively provided as spherical-bearing joints to allow each of the telescopic arm member 2 and the light member 3 to pivot or swing around the joints, resulting in their free displacements.

Furthermore, the clamping force of the screw 55 allows the above rotation and the above light angle to be retained.

In this manner, the joint part 40 may be suitably replaced with another different structure.

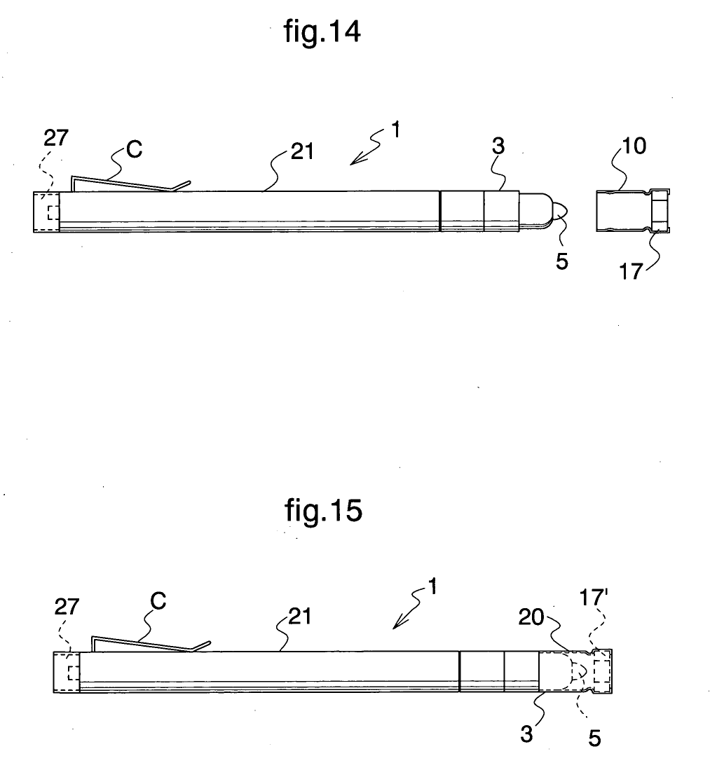

FIG. 14 shows another embodiment of the telescopic flashlight 1 in which the magnet 27 is fixed on the butt end of the external cylindrical part 21.

In this case, the magnet 27 may be built in the external cylindrical part 21 or may be integrally fixed on the butt end of the external cylindrical part 21.

In this example, the diameter of the cap member 10 and the diameter of each of the other structural components to be fit the cap member 10 are preferably adjusted so that the cap member 10 can be removably fit to the butt end of the external cylindrical portion 21 or the magnet fixed on the external side of the external cylindrical portion 21 when the detachable cap member 10 is mounted on the lighting member 3.

For example, if the outer diameter of the magnet 27 on the rear end portion of the flashlight 1 is made slightly smaller than the inner diameter of the cap 10 in advance, the cap member 10 can be integrally attached over the magnet 27 on the rear portion of the flashlight 1 to retain the cap member 10 in place when a need to remove the cap member 10 is arisen during the operation.

Furthermore, when the magnet 17 is fixed on the cap member 10 just as in the case of the above embodiment, it is preferable that the polarity of the magnet 17 corresponds with the magnet 27 on the external cylindrical portion to increase the magnetic force at the time of fixing the cap member 10 to the external cylindrical part 21.

In the above embodiment, the magnet is fixed on the butt end of the external cylindrical part 21. Alternatively, the telescopic flash light 1 may be constructed such that a cover 20 similar to the cap member 10 is integrally mounted on the lighting member 3 to magnetically attach a magnet 17′ to the cover 20.

In FIG. 15, a cylindrical cover 20 having the doughnut-shaped magnet 17′ built-in with an almost similar structure as that of the cap member 10 is integrally formed on the tip of the lighting member 3.

Furthermore, the embodiment illustrated in the figure, the magnet 27 is also fixed on the external cylindrical portion 21 just as in the case of FIG. 14. Alternatively, however, the flashlight 1 may be constructed such that the magnet 27 is not fixed on the external cylindrical portion 21 (but not shown in the figure).

Other structural features are similar to those of the above embodiment, so that the explanations thereof will be omitted from the description.

In this manner, the structure of the telescopic flashlight 1 can be simplified as the magnets 17′ and 27 are fixed thereon.

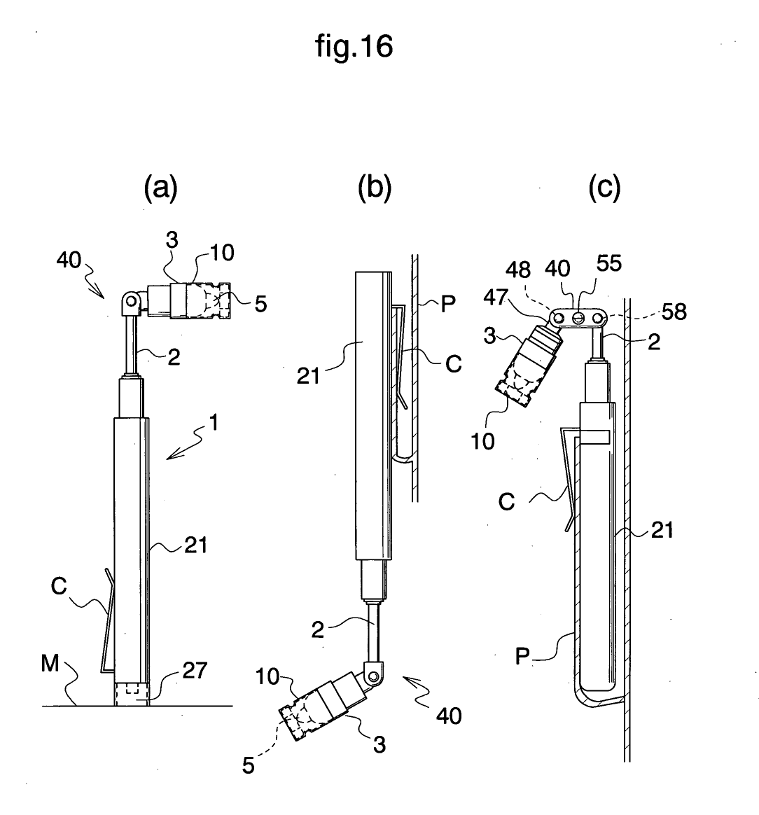

Referring now to each of FIGS. 16(a) to 16(b), there is illustrated an exemplified use of the telescopic flashlight 1 in which the lighting member 3 is designed so as to be displaceable.

In FIG. 16(a), the magnet 27 is mounted on the butt end of the external cylindrical portion 21, so that it is possible to magnetically attach the flashlight 1 to a magnetic body M such as an iron plate.

Such a usage can be also attained when the cap member 10 having the magnet 17 built-in is fit to the butt end of the external cylindrical portion 21.

Furthermore, no matter what posture the magnetic substance M maintains, the telescopic flashlight 1 can be stood on the magnetic body M.

Since the operator is allowed to change the angle of the lighting member 10 at will, so that the operator can concentrate on the work of repair or the like.

In FIG. 16(b), furthermore, by retaining the clip C on the pocket P of the user, so that the flashlight 1 can be used while hanging upside down.

In this case, the user is able to change the angle of the lighting member 10 at will, so that the work of repair or the like can be carried out while retaining the flashlight 1 on the pocket P.

In the above embodiment, there is illustrated an example in which the cap member 10 is fit to the light member 3. Alternatively, however, there is no need to mount on the flashlight 1.

In FIG. 16(c), there is illustrated the exemplified use of the flashlight 1 where the structure shown in FIG. 13(b) is used as a joint part 40. In this case, the light member 3 can be displaced to a large degree, so that the lighting member 2 can be directed directly below in use while the telescopic flashlight 1 is placed in the pocket P and the clip C thereof is retained on the pocket P.

The clip C may be integrally formed on the external cylindrical portion 21 or movably attached thereof so as to move around the periphery of the external cylindrical portion 21. Alternatively, the clip C may be detachably mounted on the external cylindrical portion 21.

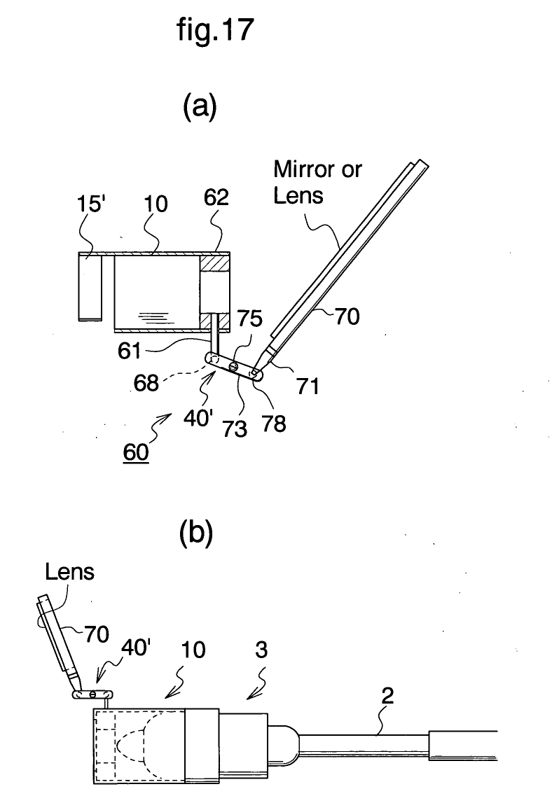

Referring now to FIG. 17(a), there is illustrated another embodiment in which an arm member 60 is mounted on the cap member 10 and a mirror, a magnifying lens, or the like is attached to the tip of the arm member 60.

The telescopic flashlight 1 used herein may have any structure of each of the embodiments described above.

Furthermore, the locking band clip 15′ is mounted to the cap member 10 which is attached in am inward direction, instead of the protruded locking part 15. In this manner, the latching means are not limited to a specific one, but cap member 10 is mounted on the lighting member 3.

The arm member 60 may be previously formed into a predetermined shape. In this embodiment, however, the same joint part 40′ as that of FIG. 13(b) is used.

That is, the butt end of a first bar member 61 is fixedly mounted on the cap member 10.

In the illustrated embodiment, a ring-like metallic attachment 62 is fixed in the inside of the cap member 10 to make the cap member 10 thicker and then the butt end of the first bar member 61 is inserted into the cap member 10 and fixed in place.

A peripheral body 68 is integrally formed on the tip of the first bar member 61.

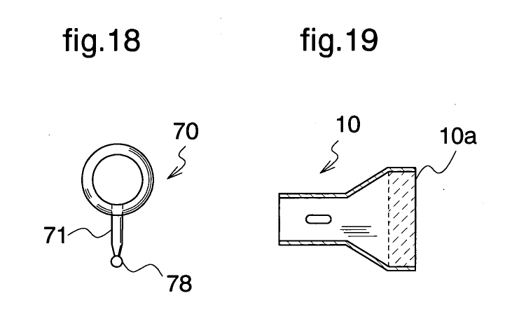

Likewise, a second bar member 71 is mounted on a retainer 70 for retaining a mirror or a magnifying lens such that it extends from the retainer 70. In addition, a spherical body 78 is integrally mounted on the tip of the second bar member 71 (see FIG. 18).

In addition, there is provided a pair of plate-like joint covers 73 having spherical recessed portions for receiving the spherical bodies 68, 78, respectively.

It is constructed such that the joint covers 73 are aligned in place so as to be placed opposite to each other. The spherical bodies 68, 78 are sandwiched between the surfaces of the respective joint covers 73 and then clamped with a fixing device 75 such as a screw (e.g., a thumbscrew).

Consequently, the mirror, magnifying lens, or the like fixed on the retainer 70 can be freely displaced. Furthermore, there is illustrated the exemplified use of the magnifying lens described above in FIG. 17(b).

Here, the retainer 70 is designed to retain a mirror or a lens (a concave lens or a convex lens), so that these structural components may be integrally fixed together, or detachably fixed together to allow their replacements.

In the above embodiment, the joint part having two spherical surface bearings are exemplified on the arm member 60. Alternatively, however, one of the joint mechanisms used in the joint part may be a pin to mount so as to be able to swing and the other may be of a spherical surface bearing. Alternatively, the joint part may be constructed using either of the pin or the spherical surface bearing to mount so as to be able to swing.

Furthermore, in the above embodiment, the cap member 10 is of a cylindrical shape. Alternatively, for example, an enlarged portion 10a where the tip thereof is of a generally horn shape as shown in FIG. 19 may be formed to increase the angle of light from the lighting portion 3.

In addition, the structure of the small-sized battery to be used as power supply is not limited to the embodiments, but cylindrical shape or other various type batteries can be used.

In the present invention, furthermore, the structure thereof is not limited to the structure of each of the above embodiments. According to the present invention, it goes without saying that part of the structure of each embodiment may be suitably combined with part of the others.

Furthermore, the cylindrical shape of the external cylindrical part or the like is not limited to a circular cylinder. Alternatively, it may be of a square cylindrical shape.

1. A telescopic flashlight that includes a lighting member mounted on the tip of a telescopic arm member having a handling member and is capable of turning on and off the light by a switching operation, comprising:
cap-attaching portions respectively formed on the butt end of the handling member and the tip of the lighting member; and
a cap member detachably attached to each of the cap-attaching portions, wherein
the cap member is allowed to be provided as a cover to be attached to the tip of the lighting member or to be attached to the butt end of the handling member to be housed thereon.

2. The telescopic flashlight according to claim 1, wherein
a generally doughnut-shaped magnet having an opening for passing light from the lighting member.

3. The telescopic flashlight according to claim 1, wherein
a coloring element to provide the light from the lighting member with color is mounted on the cap member.

4. The telescopic flashlight according to claim 1, wherein
a lens for diffusing or concentrating the light from the lighting member is mounted on the cap member.

5. The telescopic flashlight according to claim 1, wherein
an arm member of a retainer for retaining a functional part such as a mirror or a magnifying mirror is mounted on the external side of the cap member.

6. The telescopic flashlight according to claim 1, wherein
the peripheral wall of the cap member is formed of an optically transparency material.

7. The telescopic flashlight according to claim 1, wherein
the lighting member comprises: a battery-housing part for holding a small-sized battery such as a button type battery; and an emitter-holding part for holding a light-emitting member that emits light using the small-sized battery as its electric source, where the emitter-holding part is detachably connected to the battery-housing part.

8. The telescopic flashlight according to claim 7, wherein
a switching structure is provided such that a connecting portion such as a screw is formed on the inner peripheral surface or outer peripheral surface of the emitter-holding part and another connecting portion such as a screw that corresponds to the connection portion is formed on the outer peripheral surface or inner peripheral surface of the battery-housing part, so that a conductor connected to the lighting member is energized when it is brought into contact with the small-sized battery by connecting the emitter-holding part with the battery-housing part, while the conductor is not energized when it is detached from the small-sized battery by loosing the connection between the emitter-holding part and the battery-housing part to slightly move the emitter-holding part away from the battery-housing part.

9. The telescopic flashlight according to claim 1, wherein
the external cylindrical part of the telescopic arm member is provided as a handling member.

10. The telescopic flashlight according to claim 1, wherein
a power-source housing part for housing a power supply such as a battery or a secondary cell is provided on the butt end of the telescopic arm member in a connected row arrangement, and a casing of the power-supply housing part is provided as a handling member.

11. The telescopic flashlight according to claim 1, wherein
the lighting member is attached to the tip of the telescopic arm member through a joint part and the joint part is able to change the angle of the lighting member in a direction different from the extending direction of the telescopic arm member.

12. The telescopic flashlight according to claim 11, wherein
the joint part acts as a spherical surface bearing for each of the tip of the telescopic arm member and the butt end of the lighting member.

13. The telescopic flashlight according to claim 1, wherein
a clip is attached to the handling member.

14. The telescopic flashlight according to claim 5, wherein
a retaining part for retaining a mirror or a magnifying lens through an arm member having a joint part is provided on the external side of the cap member to allow the angle of the retaining part to be changed.

15. The telescopic flashlight according to claim 14, wherein
the joint part is formed of a bearing arm that acts as a spherical surface bearing of each of the tip of the arm member of the cap member and the butt end of the retaining part.

16. The telescopic flashlight according to claim 1, wherein
the cap member has an enlarged portion having a tip enlarged like a horn to extend the angle of light.

17. A telescopic flashlight according to claim 1, wherein
a telescopic flashlight, comprising:
a magnet fixed on the bottom surface of the handling member such that the bottom surface of the magnet is substantially flat to allow the flashlight to be stand itself on a magnetic body such as an iron plate by magnetically attaching to the magnetic body;
a cap-attaching portion formed on the tip of the lighting member; and
a cap member detachably attached to the cap-attaching portion, where the cap member can be used as a cover when it is attached to the tip of the lighting member.

18. The telescopic flashlight according to claim 1, wherein
the cap member is integrally formed on the lighting member.

19. The telescopic flashlight according to claim 17, wherein
the cap member is integrally formed on the lighting member.
